(19) United States
(12) Patent Application Publication
(10) Pub. No.: US 2021/0008875 A1
(43) Pub. Date: Jan. 14, 2021

(54) MEASURING PHYSICAL PARAMETERS

(71) Applicant: HEWLETT-PACKARD DEVELOPMENT COMPANY, L.P., Spring, TX (US)

(72) Inventors: Roberto A. Pugliese, Corvallis, OR (US); Jeffrey A. Nielsen, Corvallis, OR (US); Larry H. White, Corvallis, OR (US); Christie Dudenhoefer, Corvallis, OR (US)

(73) Assignee: HEWLETT-PACKARD DEVELOPMENT COMPANY, L.P., Spring, TX (US)

(21) Appl. No.: 16/955,679

(22) PCT Filed: Mar. 8, 2018
(86) PCT No.: PCT/US2018/021460

§ 371 Date: Jun. 18, 2020

(51) Int. Cl. B41J 2/045; G06F 1/03

(52) U.S. Cl. CPC B41J 2/04535; G06F 1/03; B41J 2/0457

(57) ABSTRACT

A method may include measuring at least one physical parameter of at least one component of a plurality of components of a first fluid ejection die; and calculating an operating energy value to be used to operate the first fluid ejection die based on the at least one physical parameter of the at least one component.

### BACKGROUND

Printing or dispensing devices may cause an amount of fluid to be deposited either onto the surface of a substrate or into wells contained within a substrate. Some printing devices implement an ejection chamber formed within a fluid ejection die that ejects an amount of fluid out of a nozzle and onto a predetermined location on the substrate. This ejection may be caused by any type of ejection device including a piezoelectric device or a resistive device.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a flowchart showing a method of determining die-to-die variations in operating energy, drop volume, drop velocity, and/or drop placement according to an example of the principles described herein.

FIGS. 2A, 2B, and 2C are a top plan view of a fluid chamber within a fluid ejection die, a side cut-out view of a chamber of a fluid ejection die, and a side cut-out view of a resistive device, respectively, according to an example of the principles described herein.

FIG. 3 is a block diagram of a computing device according to an example of the principles described herein.

FIG. 4 is a top plan view of a fluid dispensing device according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Inkjet printing devices may implement a resistive device and/or a piezoelectric device to eject an amount of fluid from the chamber housing these devices through a nozzle, and onto a substrate. A number of factors related to the ejection of the fluid as well as the parameters of the fluid ejection die may determine the quality of the images formed on the surface of the substrate for example, the amount of printing fluid ejected, how the fluid is ejected, how fast the fluid is ejected, the shape of the droplets of ejected print fluid, and other fluid ejection die parameters may determine the quality of images formed on the substrate. These factors may also influence the size and quality of drops delivered from a dispensing system.

Some of these parameters are a product of the physical devices within the fluid ejection die itself including the shape of the chamber formed within the silicon forming the fluid ejection die, the size of the resistive and/or piezoelectric devices used, the shape of the nozzle formed in the fluid ejection die, as well as other physical parameters. In an example, in order to understand how any given ejection device, chamber, and/or nozzle will deposit or eject an amount of printing fluid, a process may be initiated that starts with measuring the operating energy used to eject a measured drop weight of printing fluid. In this process, a representative number of fluid ejection dies would be subjected to such measurements prior to installation. The results of those measurements are then used to encode values onto all of the fluid ejection die produced based on those measurements from the representative fluid ejection dies. However, in this process, there would be no process that would account for variations among both the tested fluid ejection dies and the untested fluid ejection dies. The alternative would be to test every fluid ejection die produced which would result in extended production periods and extra production costs.

Alternatively, the operating characteristics of the fluid ejection dies and specifically the operating energy used, drop weight/volume/velocity of the ejected drops, and drop placement may be determined by measuring a firing pulse used to eject an amount of fluid. This process includes monitoring any temperature in the fluid ejection die as the operating energy is decremented. However, it has been shown through other analysis that this process does not work especially well on thermally efficient fluid ejection dies that use the energy received to a near maximum efficiency.

The present specification and the appended claims describe a method that includes measuring at least one physical parameter of at least one component of a plurality of components of a first fluid ejection die; and calculating an operating energy value to be used to operate the first fluid ejection die based on the at least one physical parameter of the at least one component.

The present specification also describes a computing device that includes a processor; and a data storage device communicatively coupled to the processor wherein the processor receives input of measurements of at least one physical parameter of at least one component of a plurality of components of a first fluid ejection die; and calculates an operating energy value to be used to operate the first fluid ejection die based on the at least one physical parameter of the at least one component.

The present specification further describes a computer program product for determining an operating energy of a fluid ejection die, the computer program product that includes a computer readable storage medium comprising computer usable program code embodied therewith, the computer usable program code to, when executed by a processor measure at least one physical parameter of at least one component of a plurality of components of a first fluid ejection die; calculate an operating energy value to be used to operate the first fluid ejection die based on the at least one physical parameter of the at least one component; and with a look-up table, determine an operating pulse, a voltage, and a pulse width used to operate the first fluid ejection die based on the calculated operating energy value

As used in the present specification and in the appended claims, the term “operating energy” is meant to be understood as any energy used to eject a fluid from a fluid ejection die. The terms firing energy may be used in connection with the term operating energy and may, in some examples, be synonymous with the term operating energy. In an example, the operation energy may include the electrical energy used to fire the resistive devices in the fluid ejection die. In an example, the operating energy may include the electrical energy used to manipulate a piezoelectric device within the fluid ejection die.

As used in the present specification and in the appended claims, the term “parameter” is mean to be understood as any value that characterizes an element of a system. In some examples, parameters of the systems and devices described result in specific operating characteristics of the devices.

As used in the present specification and in the appended claims, the term “printing fluid” is meant to be understood as any fluid that may be ejected from a fluid ejection die. In an example, the printing fluid is an ink. In an example, the printing fluid is a biological fluid that may, in an example, comprise biological components such as cells.

As used in the present specification and in the appended claims, the term “nominal” is meant to be understood as an intended characteristic that varies from an actual characteristic. By way of example, a nominal dimension of a resistive device is a dimension described by manufacturing specifications for the resistive device, where as a manufactured resistive device may vary from the nominal dimension by an amount.

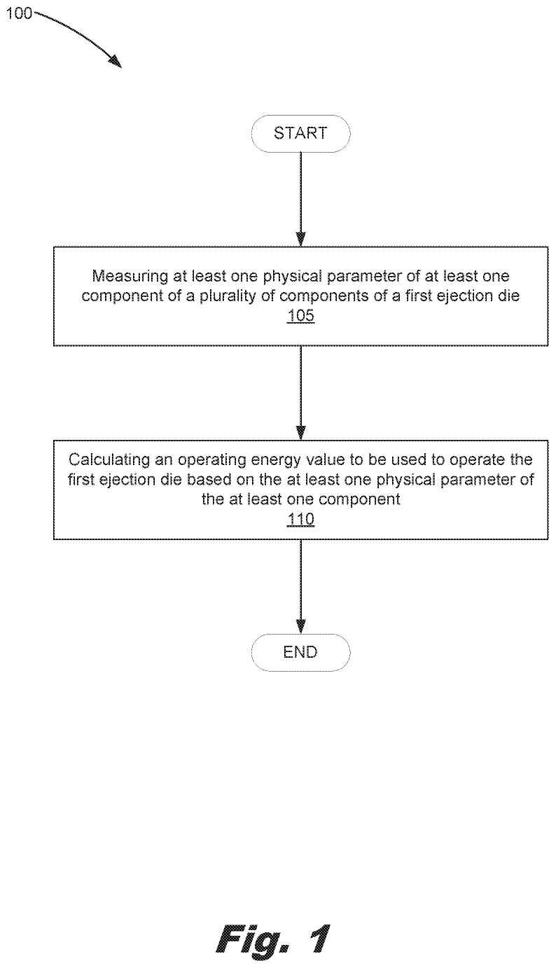

Turning now to the figures, FIG. 1 is a flowchart showing a method (100) of determining die-to-die variations in operating energy, drop volume, and drop placement according to an example of the principles described herein. The method (100) may include measuring (105) at least one physical parameter of at least one component of a plurality of components of a first fluid ejection die. Measuring (105) the at least one physical parameter may include measuring any of the physical parameters of any of the elements used to form any of the fluid ejection dies.

A fluid ejection die may include any number of elements. These elements may include, but are not limited to any number of passivation layers, any number of resistive devices, any number of piezoelectric devices, any number of nozzle plate layers, any number of bores formed into the nozzle plate to serve as nozzles through which the printing fluid is ejected, the number and length of metal traces formed within the fluid ejection dies, the volume of a print fluid chamber formed within the fluid ejection dies, the volume of the print fluid chambers relative to the size of the resistive devices and/or piezoelectric devices, the volume of any fluid flow paths within the fluid ejection die, any flow characteristics of a fluid through the fluid flow paths, among other parameters.

The method (100) may continue with calculating (110) an operating energy value to be used to operate the first fluid ejection die based on the at least one physical parameter of the at least one component. Any method may be used to calculate the operating energy described herein based on the measured physical parameters of the at least one component. In an example, the operating energy may be calculated using the following equation:

Energy=Energy_{0[(1+k}_{₁}_{Δt}_{₂}₎₍₁₊ₖ_{₂}_{Δt}_{₂}₎₍₁₊ₖ_{₃}_{Δt}_{₃}_{)]} Eq. 1

Where Energy₀ is the nominal energy for a particular fluid ejection die design, kₙ is the proportionality constant changes in energy per change in film thickness n, and Δtₙ is the change in film thickness n from the nominal value for the design being measured (105). Eq. 1, in an example, may further include a term describing a measured size of the resistor: length, width, height. In an example, the calculations used by the method (100) may take into consideration thicknesses of the resistive devices/piezoelectric devices as well as any protective layers deposited over a top portion of the resistive devices/piezoelectric devices. Any deviations from a nominal value as a result of variations in the manufacturing process may further be considered in Eq. 1.

In an example, the method (100) may further include calculating a drop volume to be ejected from the fluid ejection die based on measured physical parameters. In this example, the drop volume may be calculated using the following equation:

Volume=Volume₀[(1+k_{b}Δb)] Eq. 2

Where Volume₀ is the nominal drop volume for a particular fluid ejection die design, k_{b} is the proportionality constant for changes in drop volume per change in bore dimension, and Δb is a change in a bore dimension from the nominal value for the design. In an example, Eq. 2 may include a term for the size of a resistive device. Where the values defining the size of the resistive device deviates from the nominal, it may be due to variations in the manufacturing process.

In an example, the method (100) may include implementing a look-up table to determine an operating pulse, a voltage, and a pulse width used to operate the fluid ejection die based on the calculated operating energy value. The look-up table may be maintained on a data storage device or may be separate from the data storage device. In an example, the calculated (110) operating energy value, the calculated drop volume, the operating pulse, the voltage, and the pulse width may all be stored on the data storage device. These values may be used by a processor during operation of the fluid ejection die. In an example, these values may be directly encoded on to a data storage device placed on the fluid ejection die. In an example, these values may be encoded on a data storage device that is coupled to a pen or a printing fluid supply. In an example, these values may by encoded onto a data storage device of a printing device when the fluid ejection die is a permanent part of the printing device. In an example, these values may be stored on a data storage device communicatively coupled to the fluid ejection die, pen, and/or the printing device over a network.

Additional physical parameters of the elements of the fluid ejection die may also affect the operation of the fluid ejection die and may also be measured and used in calculating the operating energy and/or drop volume described herein. These additional physical parameters include electrical conductivity, heat conductivity, and surface tension, among others. Again, each of these additional parameters as well as those parameters described herein may be used to help predict the operating energy, drop volume, and/or drop velocity as described herein.

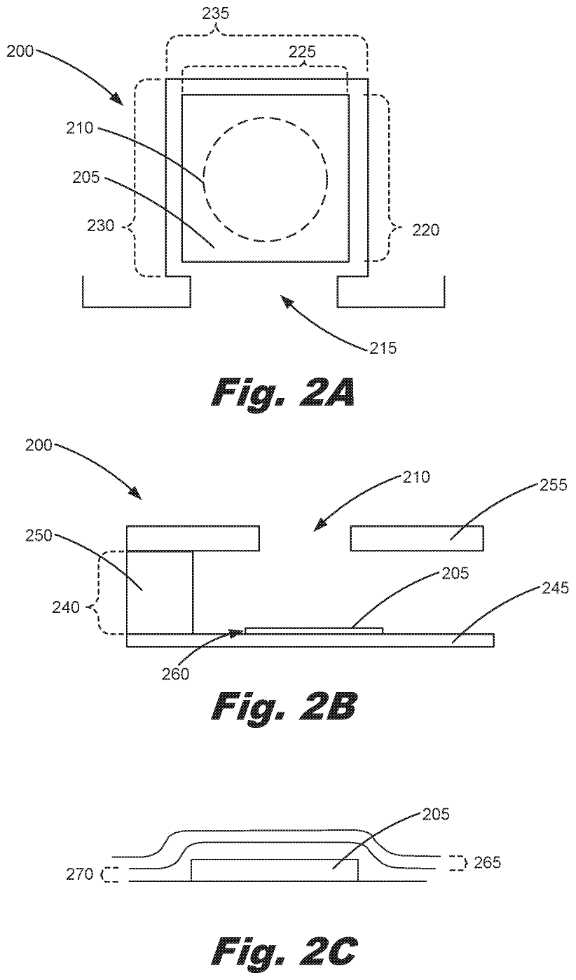

FIGS. 2A, 2B, and 2C are a top plan view, a side cut-out view of a fluid ejection die, and a side cut-out view of a resistive device, respectively, according to an example of the principles described herein. Although FIGS. 2A-2C show certain elements used to form part of a fluid ejection die, the present specification contemplates that a fluid ejection die could include additional or fewer elements and the present specification contemplates such other examples. However, the principles of determining die-to-die variations in operating energy and/or drop volume apply to these other examples by adjusting the calculation processes described herein to consider those elements present.

FIGS. 2A and 2B each show a fluid ejection chamber (200) formed within a fluid ejection die. The fluid ejection chamber (200) may include a resistive device (205) formed within the fluid ejection chamber (200). The fluid ejection chamber (200) may include a fluid flow path (215) that may introduce fluid into the fluid ejection chamber (200) as well as a bore (210) through which a fluid may be ejected from the fluid ejection chamber (200) of the fluid ejection die. Although FIGS. 2A-2C show the use of a resistive device (205), the present specification contemplates the use of any other ejection device such as a piezoelectric device. Additionally, FIGS. 2A-2C show a number of elements of a fluid ejection die being assembled to form the fluid ejection chamber (200).

The fluid ejection chamber (200) may have a certain number of dimensions associated with it. The fluid ejection chamber (200) may have a chamber length (230), a chamber width (235), and a chamber height (240). As described herein, the physical parameters including the chamber length (230), chamber width (235), and chamber height (240) may be measured. In an example, these measurements may be made while the fluid ejection die has been assembled.

In an example, these dimensions may be measured prior to assembly of the elements described herein. However, in the case of the fluid ejection chamber (200), the chamber length (230), chamber width (235), and chamber height (240) may be determined based on the physical dimensions of the elements forming the fluid ejection chamber (200). For example, the fluid ejection chamber (200) may be formed out of a number of layers: a first layer (245), a second layer (250), and a third layer (255). These layers (240, 245, 250) may each have their respective dimensions measured prior to assembly and the placement of these three layers (240, 245, 250) respective to each other. The physical dimensions of these layers (240, 245, 250) as well as their placement respective to each other may be used to help extrapolate the chamber length (230), the chamber width (235), and the chamber height (240). As a result, the volume of the fluid ejection chamber (200) may be determined. These measurements may be used in a calculation (FIG. 1, 110) of an operating energy to be used to operate the first fluid ejection die.

The fluid ejection chamber (200) may further include a resistive device (205). The resistive device (205) may also include physical parameters: a resistive device length (220), a resistive device width (225), and a resistive device height (260). These physical parameters (220, 225, 260) may be measured after fabrication of the resistive device (205). In an example, the physical parameters (220, 225, 260) of the resistive device (205) may be measured using any measuring device. The physical parameters (220, 225, 260) of the resistive device (205) may be measured and used to calculate (FIG. 1, 110) an operating energy value to be used to operate the first fluid ejection die and/or a drop volume that will be ejected from the fluid ejection die. In the example where the physical parameters (220, 225, 260) of the resistive device (205) are measured, the calculation (FIG. 1, 110) may consider the amount of heat produced by the resistive device (205). The nominal value of the heat produced by the resistive device (205) may be based on a set of predetermined physical parameters of a resistive device (205). However, the value of the heat produced by a manufactured resistive device (205) may be different because of the measured and actual physical parameters (220, 225, 260). This data may be used in any calculation (FIG. 1, 110) described herein.

In an example, the heating properties of the resistive device (205) may be affected by a number of protective layers (265, 270) covering the resistive device (205). FIG. 2C shows the resistive device (205) having a first protective layer (265) and a second protective layer (270) layered over the resistive device (205). These layers may be made of any material used to protect any portion of the resistive device (205) from damage due to the heating and cooling of a fluid maintained within and ejected from the fluid ejection chamber (200). In the course of protecting the resistive device (205) from damage, the first protective layer (265) and second protective layer (270) may also alter its heating characteristics. The thickness of each of these layers (265, 270) may be determined during manufacturing via, for example, a meter coupled to a dispenser used to dispense the layers (265, 270). The amount of heat produced by the resistive device (205) resulting from the first protective layer (265) and second protective layer (270) may be determined and may also be used to calculate (FIG. 1, 110) an operating energy value to be used to operate the fluid ejection die.

As described above, the operating energy value, drop volume, and/or drop velocity calculated (FIG. 1, 110) may be stored on a data storage device associated with the fluid ejection die. In an example, the data storage device may be coupled to the fluid ejection die itself. In an example, the data storage device may be communicatively coupled to a processor of a printing device the fluid ejection die is used in. The data storage device may include various types of memory modules, including volatile and nonvolatile memory. For example, the data storage device of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device as may suit a particular application of the principles described herein. In certain examples, different types of memory in the data storage device may be used for different data storage purposes.

Because the physical parameters (220, 225, 260, 245, 250, 255, 265, 270) described herein may be used to calculate (FIG. 1, 110) the operating energy value, drop volume, drop velocity, and/or drop placement, this data may be associated with the fluid ejection die formed by these specific elements measured. However, other fluid ejection die may also be manufactured alongside the original fluid ejection die and, due to the cost in time and/or money, may not have its elements specifically measured prior to assembly. However, those materials and elements used to form these subsequent fluid ejection die may be associated with the same operating energy value and/or drop volume values as that calculated for the first fluid ejection die. This is because certain elements used to form the subsequent fluid ejection die may originate from the same source as the first fluid ejection die. By way of example, the first layer (245), second layer (250), and/or third layer (255) may each be made of a material that was mass produced and then cut into individual pieces to form the first and subsequent fluid ejection die. The material, in one example, may be silicon. Because silicon layers are manufactured by slicing a silicon ingot to form silicon wafers, the layers may be generally the same thickness across their individual surface. This may not be the case from wafer to wafer, but a single wafer may be measured and subsequently cut to form the layers (245, 250, 255) described herein. Because these layers originated from the same silicon wafer, it can be assumed that, at least, the thickness of each of the layers (245, 250, 255) are generally the same. Additionally, the length and width of the first layer (245), second layer (250), and third layer (255) may be set based on the fabrication of each of these layers as the silicon wafer is further partitioned to form these layers (245, 250, 255).

In an example, the operating characteristics of a first fluid ejection die resulting from the measurements and calculations described herein may be used to determine an adjustment to the operation of a second fluid ejection die. In this example, the operating characteristics between any given manufactured fluid ejection die may be adjusted in order to match the operating characteristics of other manufactured fluid ejection dies. This adjustment of operating characteristics may be done by addressing the look-up-table described herein in order to determine how to alter, for example, a firing pulse to any given fluid ejection device within any fluid ejection die.

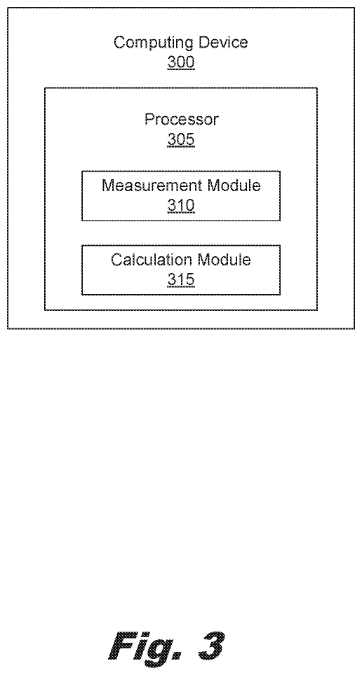

FIG. 3 is a block diagram of a computing device (300) according to an example of the principles described herein. The computing device (300) may be any type of computing device including a server, a desktop computer, a laptop computer, a personal digital assistant (PDAs), a mobile device, a smartphone, a gaming system, and a tablet, among other types of computing devices.

The computing device (300) includes a processor (305). The processor (305) may be one that can execute computer readable program code. Specifically, the processor (305) may execute computer-readable program code in the form of a measurement module (310) and a calculation module (315). The various modules within the computing device (300) comprise executable program code that may be executed separately. In this example, the various modules may be stored as separate computer program products. In another example, the various modules within the computing device (300) may be combined within a number of computer program products; each computer program product comprising a number of the modules.

The measurement module (310), when executed by the processor (305), may receive input of measurements of at least one physical parameter of at least one component of a plurality of components of a first fluid ejection die. As described above, these measurements may be taken before each of the components of the fluid ejection die are assembled together to form the fluid ejection die. The measurements taken may include physical dimension measurements of any of the components, electrical conductivity measurements of any of the components, and thermal conductivity of any of the components, among other measurements described herein.

The processor (305) may then execute the calculation module (315). The calculation module (315) may calculate an operating characteristic associated with the first fluid ejection die based on the at least one physical parameter of the at least one component. The operating characteristics may include an operating energy, a drop volume, a drop velocity, and/or a drop placement. In an example, the operating energy value may be calculated by the calculation module (315) using Equation 1 described herein. In an example, the drop volume may be calculated using Equation 2 described herein. Other equations and processes may be used by the calculation module (315) to derive any number of other operating characteristics and the present specification contemplates those other equations and processes.

The processor (305) may further cause the values associated with the operating characteristics to be stored on a data storage device associated, at least, with the components of the fluid ejection die from which the measurements were taken. In an example, the data storage device may be maintained on the fluid ejection die that has incorporated that component measured. In an example, the data storage device may be maintained on a printing device associated with the fluid ejection die that has incorporated that component measured.

The calculation module (315) and/or the processor (305) may further implement a look-up-table to, determine an operating pulse that includes a voltage and/or a pulse width used to operate the first fluid ejection die based on the calculated operating energy value. Although a look-up table is presented as an example in the present specification, the present specification contemplates the use of any type of data format and/or data device used to determine the operating pulse that includes the voltage and/or pulse width. These values in the look-up table may, therefore, also be maintained on the data storage device and may be used by a printing device during operation of the fluid ejection die. The use of the operating characteristics as well as the operating pulse, voltage, and/or pulse width allows the fluid ejection device to be operated at a most efficient state and allows the printing device to compensate for any drop volume and/or drop velocity variations among the die of any type of pen. Further, during operation, the accuracy of the ejected drops of fluid from the fluid ejection die may be increased. Where the fluid ejected is a printing fluid such as ink, this increases the quality of any printed image on a substrate. Where the fluid is a biological fluid, the accuracy in the amount ejected is improved providing better accuracy in biological testing procedures.

The computing device (300) may be utilized in any data processing scenario including, stand-alone hardware, mobile applications, through a computing network, or combinations thereof. Further, the computing device (300) may be used in a computing network, a public cloud network, a private cloud network, a hybrid cloud network, other forms of networks, or combinations thereof. In one example, the methods provided by the computing device (300) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the computing device (300) are executed by a local administrator. In any of these examples, the computing device (300) may be communicatively coupled to a data storage device in order to write to the data storage device those values calculated by the calculation module (315).

The computing device (300) may further include various hardware components. Among these hardware components may be a number of peripheral device adapters and a number of network adapters. These hardware components may be interconnected through the use of a number of busses and/or network connections. In one example, the processor, data storage device, peripheral device adapters, and a network adapter may be communicatively coupled via a bus. The hardware adapters in the computing device (300) enable the processor to interface with various other hardware elements, external and internal to the computing device (300). For example, the peripheral device adapters may provide an interface to input/output devices, such as, for example, display device, a mouse, or a keyboard. The peripheral device adapters may also provide access to other external devices such as an external storage device, a number of network devices such as, for example, servers, switches, and routers, client devices, other types of computing devices, and combinations thereof.

The present system and methods may also include a computer program product for determining an operating energy of a fluid ejection die. The computer program product may include a computer readable storage medium comprising computer usable program code embodied therewith. The computer usable program code, when executed by a processor, may measure at least one physical parameter of at least one component of a plurality of components of a first fluid ejection die. This may be accomplished using the measurement module (310) described herein. Execution of the computer usable program code may, when executed by the processor, calculate an operating energy value to be used to operate the first fluid ejection die based on the at least one physical parameter of the at least one component. This may be accomplished using the calculation module (315) described herein. Additionally, execution of the computing usable program code by the processor may allow the processor to, with a look-up table, determine an operating pulse, a voltage, and a pulse width used to operate the first fluid ejection die based on the calculated operating energy value.

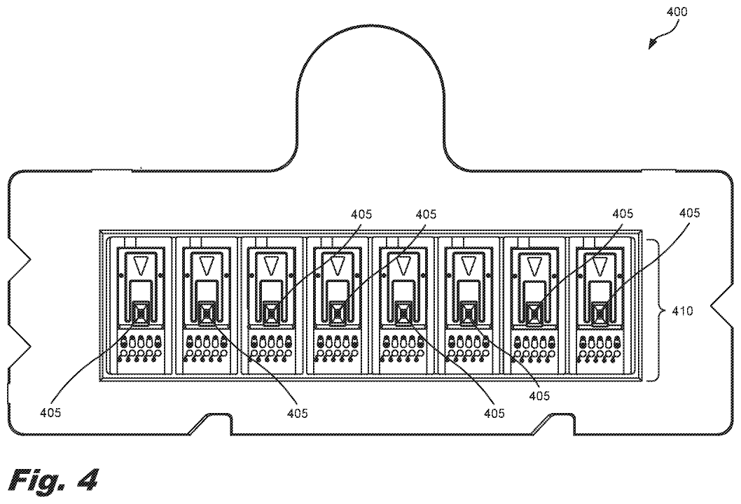

FIG. 4 is a top plan view of a fluid dispensing device (400) according to an example of the principles described herein. The fluid dispensing device (400) may include a number of individual dispensing heads (410) with each dispensing head including a fluid ejection die (405). Each of the fluid ejection die (405) may include any number of layers of material and any number of resistive devices as described herein. In an example, the materials used to form the fluid ejection die (405) may originate from different sources. By way of example, the material used to form any of the layers of material used to create the individual fluid ejection die (405) may originate from different wafers of silicon from the same lot of silicon or even different wafers of silicon from different lots. In this example, the thickness of each of the layers deposited onto the silicon may be different as well as the physical parameters of the wafers. Consequently, after the measurement of the physical parameters of the layers of the material layers on the wafers used to form the individual fluid ejection die (405), the operating energy may be calculated as described herein. The operating energy values for each of the fluid ejection die (405) based on the wafer physical parameters may be maintained on a data storage device. However, alterations may be made during operation of any one of the fluid ejection die (405) on the fluid dispensing device (400). This may be done so that the performance of a number of the fluid ejection die (405) are matched. Adjustments to the operation of any one of the fluid ejection die (405) may be, again, based on data available in the look-up table. As a result, a calculated operating energy value used to operate a first fluid ejection die may be associated with a first material source of a first component used to manufacture the first component of the first fluid ejection die and a subsequently calculated operating energy value used to operate a second fluid ejection die may be associated with a second material source of a second component used to manufacture the second fluid ejection die.

In an example, a calculated operating energy value used to operate a first fluid ejection die may be associated with both a first material source of a first component used to manufacture the first component of the first fluid ejection die. In this example, the calculated operating energy may be used to adjust an operating energy of a second fluid ejection die so that the first and second fluid ejection dies has the same or similar operating characteristics during use.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor (305) of the computing device (300) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a method to calculate an operating energy, drop volume, drop velocity, and/or drop placement from measurements of at least one component of a fluid ejection die. The use of the operating characteristics as well as the operating pulse, voltage, and/or pulse width allows the fluid ejection device to be operated at a most efficient state and allows the printing device to compensate for any drop volume and/or drop velocity variations among the die of any type of pen. Further, during operation, the accuracy of the ejected drops of fluid from the fluid ejection die may be increased. Where the fluid ejected is a printing fluid, this increases the quality of any printed image on a substrate. Where the fluid is a biological fluid, the accuracy in the amount ejected is improved providing better accuracy in biological testing procedures.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method, comprising:
measuring at least one physical parameter of at least one component of a plurality of components of a first fluid ejection die; and
calculating an operating energy value to be used to operate the first fluid ejection die based on the at least one physical parameter of the at least one component.

2. The method of claim 1, comprising storing the operating energy value on a data storage device associated with the first fluid ejection die.

3. The method of claim 1, comprising calculating a drop volume to be ejected from the first fluid ejection die based on measured physical parameters.

4. The method of claim 1, wherein measuring at least one physical parameter of at least one component of the first fluid ejection die is done prior to assembly of the plurality of components of the first fluid ejection die.

5. The method of claim 1, wherein the calculated operating energy value to be used to operate the first fluid ejection die is associated with a second fluid ejection die having a source of a component originating from materials used to manufacture the at least one component of the first fluid ejection die.

6. The method of claim 1, comprising, with a look-up table, determining an operating pulse, a voltage, and a pulse width used to operate the first fluid ejection die based on the calculated operating energy value.

7. A computing device, comprising:
a processor, and
a data storage device communicatively coupled to the processor;
wherein the processor:
with a measurement module, receives input of measurements of at least one physical parameter of at least one component of a plurality of components of a first fluid ejection die; and
with a calculation module, calculates an operating characteristic associated with the first fluid ejection die based on the at least one physical parameter of the at least one component.

8. The computing device of claim 7, wherein the operating characteristic is an operating energy value and wherein the processor, with a look-up table, determines an operating pulse used to operate the first fluid ejection die based on the calculated operating energy value; and
wherein the computing device comprises a network adaptor to communicatively couple the computing device to a data storage device associated with the first fluid ejection die.

9. The computing device of claim 8, wherein the operating characteristic associated with the first fluid ejection die may determine an adjustment to the operation of a second fluid ejection die based on data presented in the look-up table such that operating characteristics of the first and second fluid ejection dies are the same.

10. The computing device of claim 8, wherein the calculated operating energy value used to operate the first fluid ejection die is associated with:
a first material source of a first component used to manufacture the first component of the first fluid ejection die; and
a subsequently calculated operating energy value used to operate a second fluid ejection die is associated with a second material source of a second component used to manufacture the second fluid ejection die.

11. The computing device of claim 7, wherein the operating characteristic is a drop volume and wherein the calculation module, calculates the drop volume to be ejected from the first fluid ejection die based on the at least one physical parameter of the at least one component.

12. The computing device of claim 7, wherein the at least one physical parameter comprises one of a physical dimension of a silicon wafer, a physical dimension of a resistor, electrical properties of the resistor, a thickness of a protective layer, a number of protective layers, a bore dimension formed in a nozzle plate, electrical properties of a piezoelectric device, or combinations thereof.

13. A computer program product for determining an operating energy of a fluid ejection die, the computer program product comprising:
a computer readable storage medium comprising computer usable program code embodied therewith, the computer usable program code to, when executed by a processor:
measure at least one physical parameter of at least one component of a plurality of components of a first fluid ejection die;
calculate an operating energy value to be used to operate the first fluid ejection die based on the at least one physical parameter of the at least one component; and
with a look-up table, determine an operating pulse, a voltage, and a pulse width used to operate the first fluid ejection die based on the calculated operating energy value.

14. The computer program product of claim 13, wherein the at least one physical parameter comprises one of a physical dimension of a silicon wafer, a physical dimension of a resistor, electrical properties of the resistor, a thickness of a protective layer, a number of protective layers, a bore dimension formed in a nozzle plate, electrical properties of a piezoelectric device, or combinations thereof.

15. The computer program product of claim 13, the computer usable program code to, when executed by a processor stores the operating pulse, voltage, and pulse width used to operate the first fluid ejection die on a data storage device associate with the first fluid ejection die.
